(19) United States
(12) Patent Application Publication
(10) Pub. No.: US 2007/0109967 A1
(43) Pub. Date: May 17, 2007

(54) Apparatus and method for post-processing Data Rate Control value in high rate packet data system

(75) Inventor: Tae-Ho Ha, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/598,029

(22) Filed: Nov. 13, 2006

(30) Foreign Application Priority Data
Nov. 11, 2005 (KR) 2005-108269

(51) Int. Cl. H04L 12/26

(52) U.S. Cl. 370/232

(57) ABSTRACT

An apparatus and method for post-processing a Data Rate Control (DRC) value in a high rate packet data system are provided, in which a loss of data throughput can be prevented by controlling the output of the DRC value. The apparatus for post-processing a DRC value, which is included in a mobile terminal having a DRC block for calculating a DRC value from a pilot channel signal received from a base station in a high rate packet data system, includes a DRC value comparison unit, a slot counter, and a DRC value determination unit. The DRC value comparison unit compares a current DRC value transmitted from the DRC block with a previous DRC value to determine if the current DRC value and the previous DRC value are equal to each other. The slot counter counts the number of slots, i.e., acquires a duration slot count, during which the current DRC value is maintained if the current DRC value is different from the previous DRC value. The DRC value determination unit determines the current DRC value as a final DRC value if the duration slot count reaches a predetermined slot threshold.

### PRIORITY

This application claims the benefit under 35 U.S.C. § 119(a) to Korean Patent Application filed in the Korean Intellectual Property Office on Nov. 11, 2005 and assigned Serial No. 2005-108269, the entire contents of which are hereby incorporated herein by reference.

### BACKGROUND OF THE INVENTION

1. Field of the Invention

The present invention generally relates to an apparatus and method for controlling the transfer rate of forward packet data. In particular, the present invention relates to an apparatus and method for post-processing a Data Rate Control (DRC) value in a high rate packet data system, in which the output of the DRC value is controlled to prevent a loss of data throughput.

2. Description of the Related Art

With the development of mobile communication technology, much research has been conducted for high rate data transmission. A representative mobile communication system having a channel structure for high rate data transmission is a 1xEVolution Data Only (1xEV-DO) system. The 1xEV-DO system is a mobile communication system complying with a standard suggested by 3^{rd} Generation Partnership Project 2 (3GPP2) to provide data communications of an IS-2000 system.

In a forward channel of the 1xEV-DO system, a pilot channel, a forward Medium Access Control (MAC) channel, a forward traffic channel, and a forward control channel are transmitted in a Time Division Multiplexing (TDM) fashion. Data packets are transmitted through the forward traffic channel, and a control message and data packets are transmitted through the forward control channel. The forward MAC channel is used to transmit reverse rate control and power control information or as a dedicated channel for forward data transmission.

Unlike the forward channel, a reverse channel in the 1xEV-DO system has a channel that has different identification symbols for different terminals, and a reverse channel for each terminal includes a pilot channel, a reverse traffic channel, an access channel, a DRC channel, and a Reverse Rate Indicator (RRI) channel. Data packets are transmitted through the reverse traffic channel. The DRC channel is used to indicate a forward data rate that can be supported by a mobile terminal. The RRI channel is used to indicate a data rate of a data channel for reverse transmission. The access channel is used for a mobile terminal to transmit a message or traffic to a base station before a traffic channel is connected.

The structure of the 1xEV-DO system and a channel related to a DRC operation will be described with reference to FIG. 1.

FIG. 1 is a block diagram of a general 1xEV-DO system. The 1xEV-DO system includes a Packet Data Service Node (PDSN) 40 that is connected with an Internet Protocol (IP) network 50 to transmit high rate packet data to base stations 20a and 20b and Access Node Controllers (ANCs) 30a and 30b for controlling the base stations 20a and 20b. The base stations 20a and 20b communicate with a plurality of Mobile Terminals (MTs) 10a, 10b, and 10c in a wireless manner and transmit high rate packet data to one of the MTs 10a, 10b, and 10c, which has the highest data rate. The MTs, base stations and ANCs are indicated as 10, 20 and 30, respectively, in FIG. 1.

To determine a DRC value to be transmitted to a DRC channel from an MT in the 1xEV-DO system of FIG. 1, the MT measures the reception strength of a pilot signal transmitted from a base station and determines a forward data rate based on the measured reception strength. The MT transmits a DRC value corresponding to the determined forward data rate to the base station through the DRC channel. The base station then receives the DRC value and transmits packet data only to an MT in a good state at a corresponding data rate. The correspondence between a forward channel state and the DRC value may vary according to implementation, but is generally fixed during a manufacturing process of terminals.

In the 1xEV-DO system, a DRC block included in an MT determines a DRC value at intervals of a DRC length that is previously determined with reference to the strength of a forward pilot channel signal and the result of Cyclic Redundancy Check (CRC) with respect to a decoded packet. Once the MT transmits the determined DRC value to the base station, the base station performs scheduling by referring to whether a packet transmitted to the MT is fully spanned and to the result of CRC and transmits a data packet to the MT using a data rate of a previous DRC value or a data rate of the current DRC value transmitted from the MT.

As to a Signal-to-Interference and Noise Ratio (SINR) value input to the DRC block of the MT, the power of a pilot channel signal of a base station may be constant in an ideal condition and signals from other base stations exist as noises. The SINR value may sharply change during a short period due to an error in noise measurement resulting from high-speed movement of the MT or fading. If the SINR value that sharply changes is applied to calculation of the DRC value, the DRC value is directly affected by the SINR value because it is determined based on the SINR value and the result of CRC for a predetermined-period, resulting in a sharp change in the DRC value.

There is a high possibility that the DRC value that undergoes a sharp change cannot reflect the actual channel condition. As a result, the result of CRC is likely to be ‘bad’. If the result of CRC is reflected to determine the next DRC value, the DRC value decreases and thus data throughput may be reduced.

Hereinafter, a reduction in data throughput due to a sharp change in the DRC value will be described in detail.

Even when the DRC value undergoes a sharp change due to a sharp change in the SINR value, a base station neglects the current DRC value received from an MT and transmits a data packet to the MT using a previous DRC value if a packet transmitted from the MT is not fully spanned and the result of CRC is not acquired. However, in a period during which the DRC value sharply changes due to a sharp change in the SINR value, the result of CRC with respect to previous data received by the MT is likely to be ‘bad’. In this case, the base station receives the DRC value that sharply changes from the MT and transmits data.

As a result, a problem occurs when the DRC value calculated by the MT does not reflect the actual channel state. If the current DRC value sharply changes to a lower value than a previous DRC value, the MT receives data at a lower data rate than the actual possible data rate. Thus, even if the result of CRC is ‘good’, a loss in data throughput is generated. If the current DRC value sharply changes to a higher value than the previous DRC value, the result of CRC is likely to be ‘bad’. The result of CRC is reflected to determine the next DRC value, causing the DRC value to decrease. As a result, a loss in the overall amount of data processed is generated.

The sharp change in the DRC value is connected directly with a loss in data throughput. To prevent the sharp change in the DRC value, a SINR value input to the DRC block may undergo long term filtering. However, to this end, the structure of the MT becomes complex and expensive to manufacture in terms of hardware.

In other words, according to the prior art, when the SINR value input to the DRC block of the MT sharply changes, the DRC value calculated from the DRC block may also sharply change. To prevent the sharp change in the DRC value, the input SINR is used or is filtered for use. The SINR value is expressed with about 16 bits and is measured for each slot or each half slot.

However, since the SINR value is expressed with 16 bits and is generated for each slot or each half slot, much burden is imposed in terms of hardware in order for the MT to perform long term filtering to prevent the sharp change in the SINR value. Moreover, it cannot be guaranteed that a desired result can be acquired from the DRC value at all times by processing the SINR value. Furthermore, in practice, the SINR value calculated by the DRC block changes a little at low lor/loc, and the frequency of a sharp change in the DRC value is low. However, the frequency of a sharp change in the SINR value is high at high lor/loc and thus the DRC value also sharply changes.

When the SINR value input to the MT sharply changes due to high-speed movement of the MT, a sharp change in a channel condition resulting from fading, or an error in noise measurement, the DRC value calculated by the DRC block of the MT also sharply changes, resulting in a loss of data throughput.

A need therefore exists for an apparatus and method for post-processing a Data Rate Control (DRC) value in a high rate packet data system, in which a gain of data throughput can be improved

### SUMMARY OF THE INVENTION

It is, therefore, an object of an exemplary embodiment of the present invention to provide an apparatus and method for post-processing a Data Rate Control (DRC) value in a high rate packet data system, in which a gain of data throughput can be improved.

It is another object of an exemplary embodiment of the present invention to provide an apparatus and method for post-processing a Data Rate Control (DRC) value in a high rate packet data system, in which a loss in data throughput due to a sharp change in the DRC value can be prevented.

It is further another object of an exemplary embodiment of the present invention to provide an apparatus and method for post-processing a Data Rate Control (DRC) value in a high rate packet data system, in which a Mobile Terminal (MT) determines the final DRC value based on a previous DRC value and the packet size and full span length of the current DRC value.

To achieve the above and other objects, there is provided an apparatus for post-processing a Data Rate Control (DRC) value, which is included in a mobile terminal having a DRC block for calculating a DRC value from a pilot channel signal received from a base station in a high rate packet data system. The apparatus comprises a DRC value comparison unit, a slot counter, and a DRC value determination unit. The DRC value comparison unit compares a current DRC value transmitted from the DRC block with a previous DRC value to determine if the current DRC value and the previous DRC value are equal to each other. The slot counter counts the number of slots, i.e., acquires a duration slot count, during which the current DRC value is maintained if the current DRC value is different from the previous DRC value. The DRC value determination unit determines the current DRC value as a final DRC value if the duration slot count reaches a predetermined slot threshold.

According to another aspect of the present invention, there is provided a method for post-processing a Data Rate Control (DRC) value for a mobile terminal having a DRC block for calculating a DRC value from a pilot channel signal received from a base station in a high rate packet data system. The method comprises comparing a current DRC value transmitted from the DRC block with a previous DRC value to determine if the current DRC value and the previous DRC value are equal to each other, counting the number of slots, i.e., acquiring a duration slot count, during which the current DRC value is maintained if the current DRC value is different from the previous DRC value, and determining the current DRC value as a final DRC value if the duration slot count reaches a predetermined slot threshold.

According to another aspect of an exemplary embodiment of the present invention, there is provided a mobile terminal for calculating a Data Rate Control (DRC) value from a pilot channel signal received from a base station in a high rate packet data system. The mobile terminal comprises a modem module, and a DRC value post-processor. The modem module includes a DRC block that calculates the DRC value preferably every slot based on the strength of the pilot channel signal and a Cyclic Redundancy Check (CRC) result with respect to a decoded packet. The DRC value post-processor determines whether a current DRC value transmitted from the DRC block is equal to a previous DRC value, counting the number of slots, i.e., acquiring a duration slot count, during which the current DRC value is maintained if the current DRC value is different from the previous DRC value, and determines the current DRC value as a final DRC value if the duration slot count reaches a predetermined slot threshold.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a general 1xEvolution Data Only (EV-DO) system;

FIGS. 2 through 4 illustrate an example in which a loss of data throughput is generated when a Data Rate Control (DRC) value sharply changes;

FIG. 5 is a block diagram of a mobile terminal including a DRC value post-processor according to an exemplary embodiment of the present invention;

FIG. 6 is a block diagram of a DRC value post-processor according to an exemplary embodiment of the present invention; and

FIGS. 7A and 7B are flowcharts illustrating a method for post-processing a DRC value according to an exemplary embodiment of the present invention.

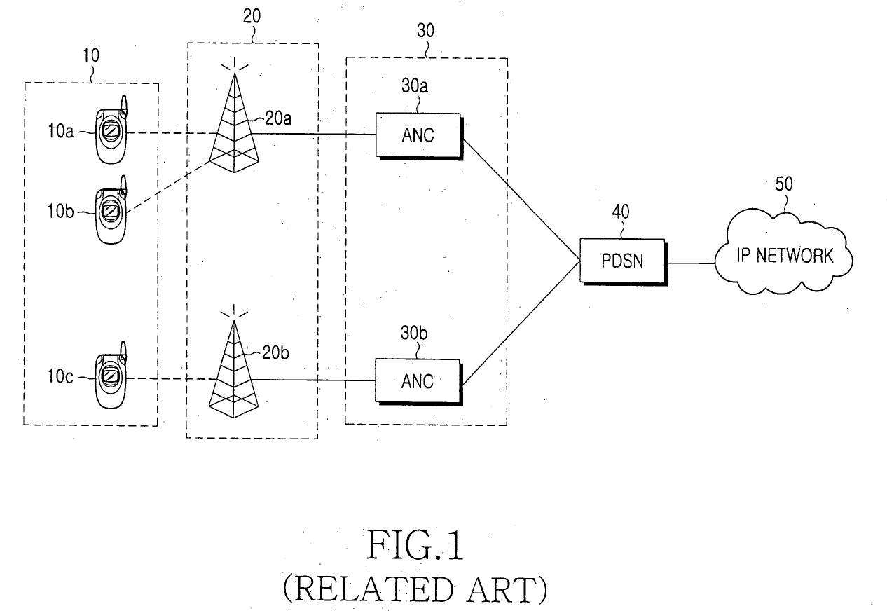

Throughout the drawings, the same drawing reference numerals will be understood to refer to the same elements, features and structures.

### DETAILED DESCRIPTION OF THE EXEMPLARY EMBODIMENTS

An exemplary embodiment of the present invention will now be described in detail with reference to the annexed drawings. The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, in the following description, a detailed description of known functions and configurations incorporated herein has been omitted for conciseness.

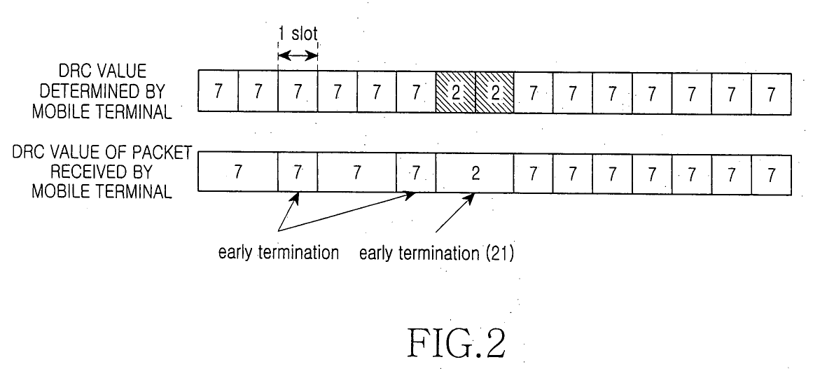

To facilitate understanding of the present invention, an example in which a loss in data throughput is generated when a sharp change in a DRC value occurs will be described with reference to FIGS. 2 through 4.

First, a mobile terminal transmits a determined DRC value to a base station for every slot. The base station then receives the DRC value and uses a data rate at which the mobile terminal desires to receive data for a slot corresponding to a DRC length.

As shown in FIG. 2, it is assumed that a DRC length is 1 slot, a period (marked with dashed lines) in which the DRC value sharply decreases to ‘2’ is generated during a period in which the DRC value is maintained as ‘7’, the full span of the DRC value ‘7’ is 2 slots, and the full span of the DRC value ‘2’ is 8 slots. At this time, if the DRC value ‘2’ is acquired due to an error of a Signal-to-Interference and Noise Ratio (SINR) measurement means included in the mobile terminal even when the DRC value ‘7’ can be obtained under the actual channel condition, a low data rate is applied for 2 slots and a Cyclic Redundancy Check (CRC) result may undergo early termination 21 within 8 slots corresponding to the full span of the DRC value ‘2’. However, if early termination as shown in FIG. 2 occurs frequently, the mobile terminal receives data at a data rate corresponding to the DRC value ‘2’ even if it can receive data at a data rate corresponding to the DRC value ‘7’. As a result, a loss is generated in terms of data throughput.

Thus, if the DRC values of a period (marked with dashed lines) in which the DRC values decrease to ‘2’ can be maintained as ‘7’ in a condition like FIG. 2, a gain can be acquired in terms of data throughput.

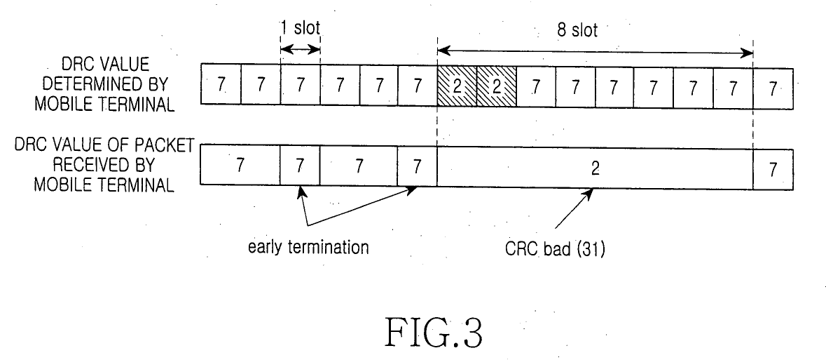

As shown in FIG. 3, if the channel condition gets worse after the DRC value is determined to be ‘2’ as marked with dashed lines, the mobile terminal has to wait during 8 slots corresponding to the full span of the DRC value ‘2’ without receiving data. In this case, if the DRC value ‘7’ is maintained, the CRC result is ‘bad’ 31 during 2 slots corresponding to the full span of the DRC value ‘7’.

If the mobile terminal selects the minimum DRC value ‘1’ in the channel condition like FIG. 3, it can resume data reception, thereby acquiring a gain in terms of data throughput.

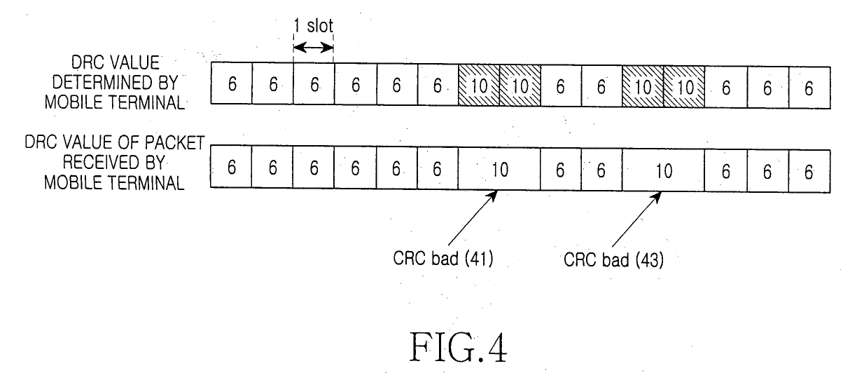

As shown in FIG. 4, it is assumed that the DRC value sharply changes from ‘6’ whose full span is 1 slot to ‘10’ whose full span is 2 slots due to an error in an SINR measurement means included in the mobile terminal and the DRC length is 1 slot. In this case, since the DRC values corresponding to 2 slots sharply change to ‘10’ as marked with dashed lines even though the DRC value is ‘6’ in the actual channel condition, the mobile terminal cannot receive data transmitted at a data rate corresponding to the DRC value ‘10’ in a channel condition corresponding to 2 slots. As a result, CRC results may be ‘bad’ 41 and 43 and the mobile terminal returns to the DRC value ‘6’ after the full span of the DRC value ‘10’.

Thus, in the channel condition like FIG. 4, the mobile terminal cannot receive data of 4 slots. In this case, if the mobile terminal can continuously maintain the DRC value ‘6’, a gain can be acquired in terms of data throughput.

Therefore, the present invention suggests a method for post-processing a DCR value in which the mobile terminal filters a DRC value determined according to the prior art using a simple hardware structure and determine the final DRC value in order to acquire data throughput. The method for post-processing a DRC value according to the present invention can be used in both 1xEV-DO Release 0 and Release A and can also be applied to future Release versions if the data packet size of a canonical transmission format and the data packet size of a nominal transmission format of the same DRC values are equal to each other.

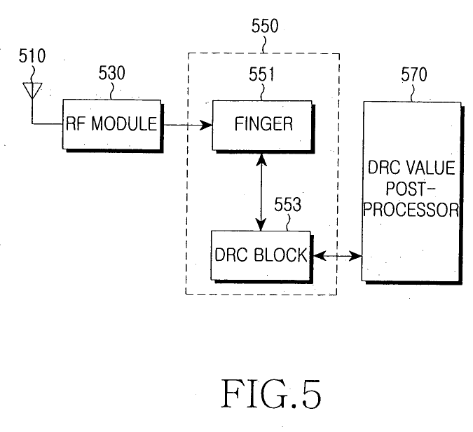

FIG. 5 is a block diagram of a mobile terminal including a DRC value post-processor according to an exemplary embodiment of the present invention.

In FIG. 5, if a pilot channel signal of a base station is received through an antenna 510, the pilot channel signal is Radio-Frequency (RF) processed by an RF module 530 through frequency down-conversion and then delivered to a modem module 550 for performing modulation/demodulation. The modem module 550 includes a Rake receiver (not shown) for separating reception signals that are reflected with different time delays in a multi-path fading environment.

The Rake receiver includes a plurality of fingers 551 for demodulating a signal of each path and one finger 551 is shown for convenience of explanation. The finger 551 measures the energy and SINR value of the received pilot channel signal, and the measured SINR value is delivered to a DRC block 553 included in the modem module 550. The DRC block 553 calculates a DRC value every slot by referring to the strength of a forward pilot channel signal received from the base station and a result of CRC with respect to a decoded packet.

In FIG. 5, the DRC value calculated by the DRC block 553 is delivered to a DRC value post-processor 570 according to the present invention, The DRC value post-processor 570 compares a currently calculated DRC value (hereinafter, referred to as a current DRC value) with a previously applied DRC value (hereinafter, referred to as a previous DRC value) to determine whether the DRC value sharply changes, observes a change in the DRC value during a slot threshold to be described later if a sharp change in the DRC value is detected, and determines one of the previous DRC value and the current DRC value, which is suitable for the current channel condition, as the final DRC value, according to a DRC post-processing algorithm in accordance with an exemplary embodiment of the present invention.

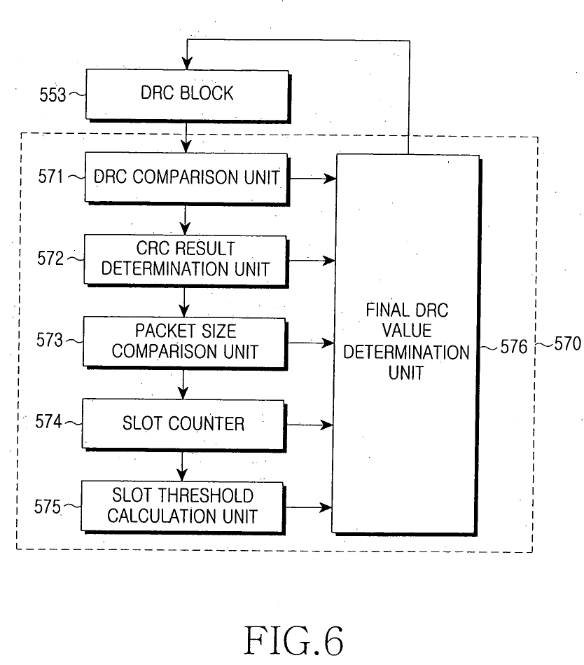

FIG. 6 is a block diagram of the DRC value post-processor 570 according to an exemplary embodiment of the present invention. The DRC value post-processor 570 shown in FIG. 6 post-processes the previous DRC value and the current DRC value transmitted from the DRC block 553 of FIG. 5 according to an exemplary embodiment of the present invention and outputs the final DRC value.

If the DRC block 553 included in the modem module 550 of FIG. 5 receives an SINR value from the finger 551 and calculates and then outputs the DRC value corresponding to the current slot (or the current DRC value), the output current DRC value is delivered to a DRC value comparison unit 571 included in the DRC value post-processor 570. The DRC block 553 can store a DRC value corresponding to a previous slot (or a previous DRC value) in an internal memory (not shown) and delivers the stored previous DRC value and the current DRC value to the DRC value comparison unit 571. Although the previous DRC value is stored within the DRC block 553 in the current embodiment of the present invention, it may also be stored in the DRC value post-processor 570.

The DRC value comparison unit 571 determines if the current DRC value and the previous DRC value that are transmitted from the DRC block 553 are equal to each other or at least substantially similar to each other in order to determine whether to apply a DRC post-processing algorithm according to the present invention. If the current DRC value and the previous DRC value are equal or similar to each other, the DRC value comparison unit 571 notifies a final DRC value determination unit 576 of the fact and the final DRC value determination unit 576 determines the current DRC value as the final DRC value. The final DRC value is transmitted to a base station through a DRC channel. If the current DRC value and the previous DRC value are not equal to each other, the DRC value comparison unit 571 notifies a CRC result determination unit 572 of the fact.

If a CRC result corresponding to the previous DRC value is not acquired, the CRC result determination unit 572 notifies the final DRC value determination unit 576 of the fact, and the final DRC value determination unit 576 determines the current DRC value as the final DRC value. In the current exemplary embodiment of the present invention, the current DRC value transmitted from the DRC block 553 is maintained until the CRC result corresponding to the previous DRC value is acquired. If the CRC result is ‘good’, the CRC result determination unit 572 notifies the final DRC value determination unit 576 of the fact, and the final DRC value determination unit 576 determines the current DRC value as the final DRC value. If the CRC result is ‘bad’, the CRC result determination unit 572 notifies a packet size comparison unit 573 of the fact.

The packet size comparison unit 573 compares the packet size of the current DRC value with the packet size of the previous DRC value. If those packet sizes are the same as each other, the packet size comparison unit 573 compares the current DRC value with the previous DRC value. If the previous DRC value is greater than the current DRC value, i.e., a previous data rate is higher than a current data rate, the packet size comparison unit 573 notifies the final DRC value determination unit 576 of the fact, and the final DRC value determination unit 576 determines the current DRC value as the final DRC value. If the previous DRC value is less than the current DRC value, i.e., the previous data rate is lower than the current data rate, the packet size comparison unit 573 notifies the final DRC value determination unit 576 of the fact, and the final DRC value determination unit 576 determines the previous DRC value as the final DRC value. If the packet size of the current DRC value and the packet size of the previous DRC value are not the same as each other, the packet size comparison unit 573 notifies a slot counter 574 of the fact.

The slot counter 574 counts the number of slots (hereinafter, referred to as a duration slot count) during which a changed DRC value (hereinafter, referred to as a temporary DRC value) continues. The temporary DRC value and the duration slot count are stored in a memory (not shown) of the DRC value post-processor 570. The duration slot count is compared with a slot threshold to be described later and is used to determine whether to apply the temporary DRC value. The duration slot count is delivered to the final DRC value determination unit 576. The slot counter 574 initially sets the current DRC value to the temporary DRC value when the DRC value is changed in order to acquire the duration slot count and notifies a slot threshold (Slot TH) calculation unit 575 of the change in the DRC value.

When the DRC value is changed, the slot threshold calculation unit 575 sets a slot threshold for determining whether to apply the temporary DRC value. The current DRC value is compared with the previous DRC value and, if the current DRC value is greater than the previous DRC value, the slot threshold calculation unit 575 sets a slot threshold that is larger than the full span of the previous DRC value that is currently applied in order to determine whether a channel condition actually gets better. If the current DRC value is less than the previous DRC value, the slot threshold calculation unit 575 sets a slot threshold that is equal to or less than the full span of the previous DRC value so that the DRC value can be rapidly changed in a channel condition that gets worse. The set slot threshold is delivered to the final DRC value determination unit 576.

When the final DRC value determination unit 576 is notified by the DRC value comparison unit 571 that the previous DRC value and the current DRC value are equal to each other, or by the packet size comparison unit 573 that the previous DRC value is greater than the current DRC value, or when the CRC result is not acquired from the CRC result determination unit 572, or when the CRC result with respect to the previous DRC value is ‘good,’ or when the duration slot count of the temporary DRC value, which is transmitted from the slot counter 574, reaches the slot threshold, the final DRC value determination unit 576 determines the current DRC value as the final DRC value.

When the finial DRC value determination unit 576 is notified by the packet size comparison unit 573 that the previous DRC value is less than the current DRC value, or when the slot threshold calculation unit 575 sets a slot threshold for the temporary DRC value, or when the duration slot count of the temporary DRC value which is transmitted from the slot counter 574 does not reach the slot threshold, the final DRC value determination unit 576 determines the previous DRC value as the final DRC value. The final DRC value determination unit 576 then transmits the final DRC value to the base station based on the DRC length through a transmission means (not shown).

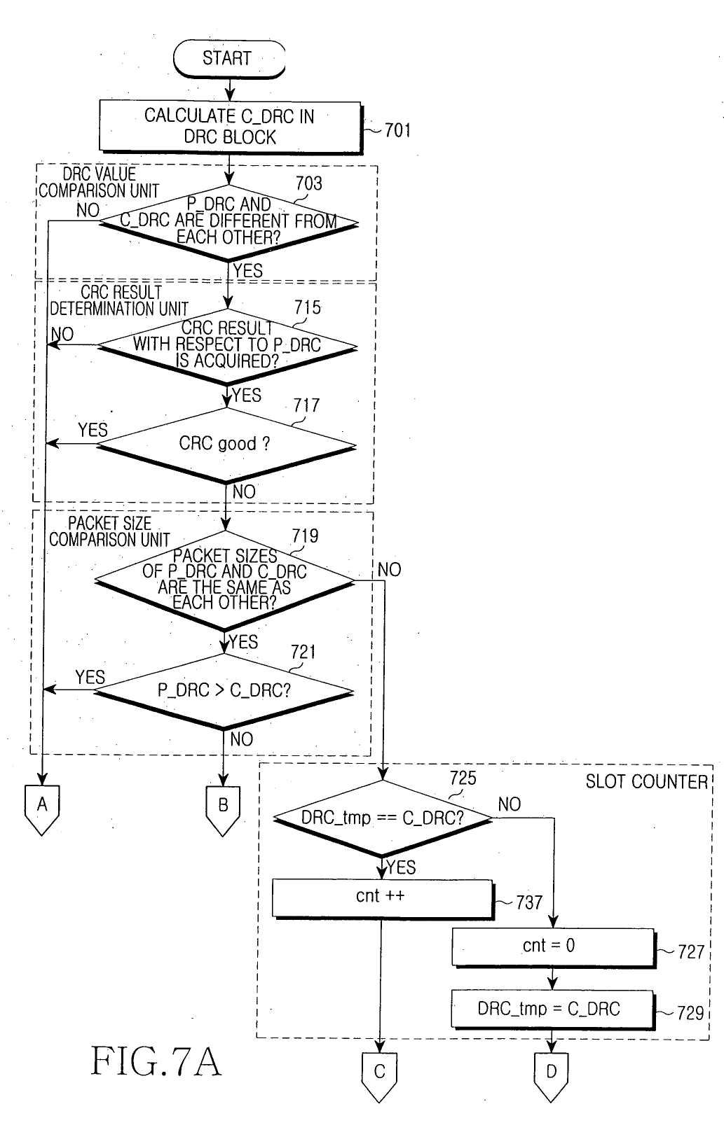

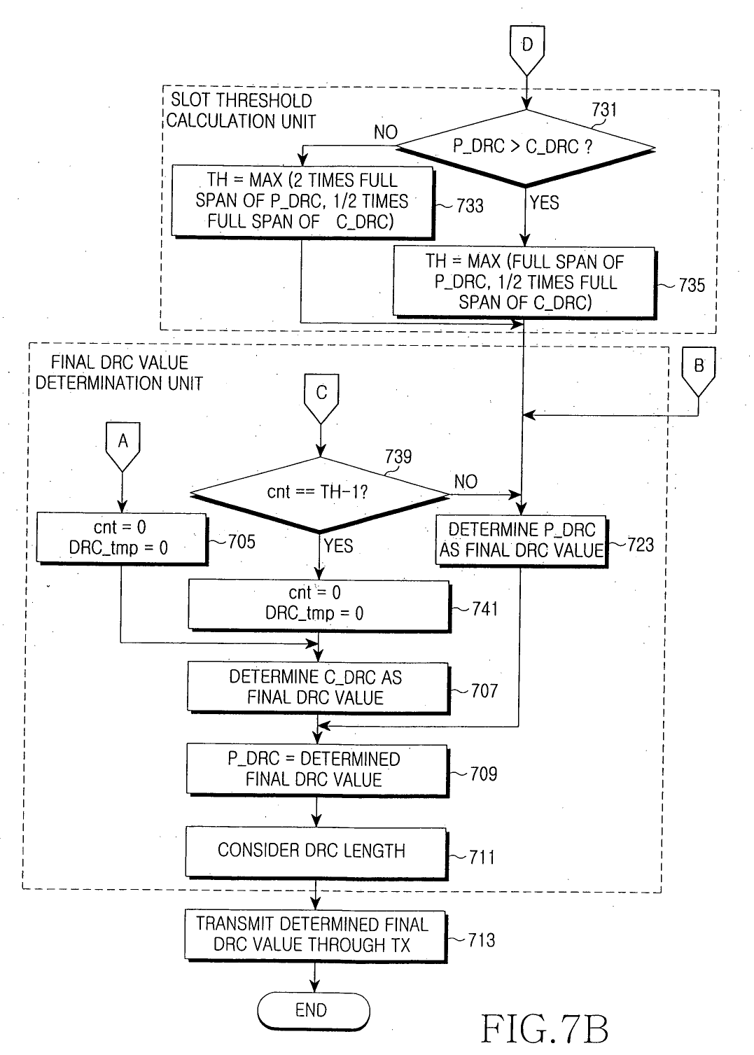

In FIG. 6, the CRC result determination unit 572 for determining the final DRC value using the CRC result, and the packet size comparison unit 573 for determining the final DRC value according to a difference between the data rate corresponding to the previous DRC value and the data rate corresponding to the current DRC value, can be optionally included and such options can also be applied to a method shown in FIGS. 7A and 7B.

FIGS. 7A and 7B are flowcharts illustrating a method for post-processing a DRC value according to an exemplary embodiment of the present invention. The method for post-processing a DRC value corresponds to a DRC post-processing algorithm according to the present invention. Steps in FIGS. 7A and 7B are preferably performed with respect to the current DRC value calculated from the DRC block 553 during every slot. To facilitate understanding of the present invention, each component of FIG. 6A for performing corresponding steps is marked with dotted lines in FIGS. 7A and 7B.

Referring to FIG. 7A, in step 701, if the DRC block 553 included in the modem module 550 receives an SINR value from the finger 551 and calculates and outputs a DRC value corresponding to the current slot, the current DRC value is delivered to the DRC value comparison unit 571 of the DRC value post-processor 570. In step 703, the DRC value comparison unit 571 compares a previous DRC value P_DRC with the current DRC value C_DRC to determine whether they are equal to each other. If the current DRC value C_DRC and the previous DRC value P_DRC are the same as each other, the final DRC value determination unit 576 initializes the temporary DRC value and its duration slot count to 0 in step 705 of FIG. 7B. The final DRC value determination unit 576 determines the current DRC value C_DRC as the final DRC value in step 707 and sets the determined final DRC value as the previous DRC value P_DRC for determination of a DRC value corresponding to the next slot in step 709. In steps 711 and 713, the final DRC value determination unit 576 transmits the final DRC value to the base station based on the DRC length through a transmission means (not shown).

If the current DRC value C_DRC and the previous DRC value P_DRC are not the same as each other in step 703 of FIG. 7A, the CRC result determination unit 572 determines whether a CRC result with respect to the previous DRC value is acquired in step 715. The final DRC value determination unit 576 goes to step 707 to set the current DRC value as the final DRC value until the CRC result corresponding to the previous DRC value is acquired. The CRC result determination unit 572 has to determine whether a CRC result with respect to a packet corresponding to the previous DRC value is acquired because the CRC result can be known after several slots for a reason such as a hardware processing time. The CRC result determination unit 572 obtains the CRC result in step 717. Thus, if the CRC result is ‘good’, the final DRC value determination unit 576 goes to step 707 to determine the current DRC value as the final DRC value. If a channel condition is good and thus the CRC result is ‘good’ even when a sharp change in the DRC value occurs, it is possible to prevent data throughput from being reduced due to application of the previous DRC value. If the CRC result is ‘bad’ in step 717, the packet size comparison unit 573 compares the packet size of the current DRC value with the packet size of the previous DRC value in step 719.

In step 719, the packet size comparison unit 573 compares the packet size of a canonical transmission format of the current DRC value with the packet size of a canonical transmission format of the previous DRC value. If the packet sizes for the two DRC values are the same as each other, the packet size comparison unit 573 selects one of the current DRC value and the previous DRC value, which corresponds to a lower data rate, in step 721. Since the DRC value is proportional to a data rate, the packet size comparison unit 573 goes to step 705 if the previous DRC value is greater than the current DRC value, i.e., a previous data rate is higher than a current data rate, and the final DRC value determination unit 576 determines the current DRC value corresponding to a lower data rate as the final DRC value. If the previous DRC value is less than the current DRC value, i.e., the previous data rate is lower than the current data rate, the packet size comparison unit 573 goes to step 723 and the final DRC value determination unit 576 determines the previous DRC value corresponding to a lower data rate as the final DRC value.

A DRC value corresponding to a lower data rate is determined as the final DRC value because a DRC value corresponding to a lower data rate has a longer full span and thus undergoes early termination in a good channel condition, and data can be stably received for the full span in a band channel condition. If the packet size of a canonical transmission format of the current DRC value and the packet size of a canonical transmission format of the previous DRC value are not the same as each other in step 719, a process goes to step 725. The reason why the packet sizes of only the canonical transmission formats are compared with each other is that the packet sizes of nominal transmission formats of DRC values are also the same as each other if the packet sizes of canonical transmission formats of the DRC values are the same each other.

In order to determine if the temporary DRC continues during the slot threshold calculated by the slot threshold calculation unit 575 if the DRC value is changed during a specific slot, a temporary DRC value DRC tmp that is the changed DRC value and a slot threshold TH to be compared with the duration slot count cnt of the temporary DRC value DRC_tmp should first be set. Thus, when the DRC value is changed, the slot counter 574 determines whether current DRC value is equal to the temporary DRC value DRC_tmp in step 725. The temporary DRC value DRC_tmp is initialized to 0. If the current DRC value and the temporary DRC value DRC_tmp are not equal to each other, the slot counter 574 initializes the duration slot count cnt during which the temporary DRC value DRC_tmp continues to 0 in step 727 and sets the current DRC value to the temporary DRC value DRC_tmp in step 729.

Once the temporary DRC value DRC_tmp is set, the slot threshold calculation unit 575 sets the slot threshold TH that determines the time point of actually applying the temporary DRC value when the temporary DRC value is maintained using different determination functions according to the previous DRC value P_DRC and the current DRC value C_DRC in the current exemplary embodiment of the present invention. To this end, the slot threshold calculation unit 575 compares the current DRC value C_DRC with the previous DRC value P_DRC in step 731. If the previous DRC value P_DRC is less than the current DRC value C_DRC, it means that the current DRC value increases and a channel condition gets better. In this case, the slot threshold calculation unit 575 sets the slot threshold TH using the following determination function in step 733:
Slot Threshold (TH)=MAX (½ times of the full span of C_DRC, 2 times the full span of P_DRC) (1)

According to Equation (1), when the current DRC value is greater than the previous DRC value, the slot threshold (TH) is determined as the maximum slot number between ½ times the full span of the current DRC value and 2 times the full span of the previous DRC value. Thus, when the DRC value sharply increases to a higher value, the mobile terminal can determine if a channel condition actually gets better during the slot threshold TH that is larger than the full span of the previous DRC value.

If the previous DRC value P_DRC is greater than the current DRC value C_DRC, it means that the current DRC value decreases and a channel condition gets worse. In this case, the slot threshold calculation unit 575 sets the slot threshold TH using the following determination function in step 735:
Slot Threshold (TH)=MAX (½ times the full span of C_DRC, full span of P_DRC) (2)

According to Equation (2), when the current DRC value is less than the previous DRC value, the slot threshold (TH) is determined as the maximum slot number between ½ times the full span of the current DRC value and the full span of the previous DRC value. Thus, when the DRC value sharply decreases to a lower value, the CRC result is likely to be ‘bad’ if the current DRC value is maintained. Therefore, the DRC value can be changed to a lower DRC value as quickly as possible.

Equations (1) and (2) are only examples of determination functions for increasing or decreasing the slot threshold (TH) according to a channel condition, and other various determination functions for increasing or decreasing the slot threshold (TH) according to a channel condition may be used instead of Equations (1) and (2) in accordance with alternative embodiments of the present invention.

In Equations (1) and (2), the maximum slot number between ½ times the full span of the current DRC value C_DRC and the full span of the previous DRC value P_DRC or 2 times thereof is determined as the slot threshold TH in order to prevent ‘1’ from being determined as the slot threshold TH and to determine that the temporary DRC value DRC_tmp is reliable if the temporary DRC value DRC_tmp is maintained during ½ times the full span of the current DRC value C_DRC. In addition, a MAX function is used in order to prevent the DRC value from being changed only during one slot when the full span of the previous DRC value P_DRC is 1.

Once the slot threshold TH is set in step 733 or 735, the final DRC value determination unit 576 goes to step 723 to determine the previous DRC value as the final DRC value and repeats its operation.

If the current DRC value C_DRC is equal to the previous DRC value P_DRC in step 725, the slot counter 574 acquires the duration slot count cnt during which the temporary DRC value DRC_tmp continues one-by-one in step 737. The duration slot count cnt is delivered to the final DRC value determination unit 576. In step 739, the final DRC value determination unit 576 determines if the duration slot count cnt is equal to ‘slot threshold (TH)−1’. If the duration slot count cnt is equal to ‘slot threshold (TH)−1’, the final DRC value determination unit 576 determines that the temporary DRC value DRC_tmp is matched with the actual channel condition, initializes the temporary DRC value DRC_tmp to 0 to set the next temporary DRC value and its duration slot count in step 741, and goes to step 707 to determine the current DRC value C_DRC as the final DRC value. At this time, the current DRC value C_DRC is equal to the temporary DRC value DRC_tmp according to step 725.

The reason why the duration slot count cnt is compared with ‘slot threshold (TH)−1’ in step 739 is that the slot threshold TH is set to an integer that is greater than 1 according to the determination functions of Equations (1) and (2) and the duration slot count cnt that undergoes step 737 has a minimum value of 1. In step 709, the determined DRC value is set to a previous DRC value P_DRC for determination of a DRC value corresponding to the next slot. In steps 711 and 713, the final DRC value determined by the final DRC value determination unit 576 is transmitted to the base station every slot through a transmission means (not shown) based on the DRC length. If the DRC length is ‘8’, the DRC value post-processor according to an exemplary embodiment of the present invention performs the steps described above preferably every slot and maintains the final DRC value during 8 slots.

When using the method suggested in the present invention, a DRC value of 4 bits can be determined using an SINR value generated every at least one slot, thereby reducing burden in hardware and algorithm terms. If an SINR value is measured every half slot and the same algorithm is used to filter an SINR value and a DRC value, a gain can be acquired in terms of hardware. In addition, since a small amount of data is processed, a gain can be acquired in terms of processing time.

In other words, if the SINR value is composed of 16 bits and is detected two times for one slot, data of 32 bits is generated during one slot. In contrast, in the present invention, the DRC value is composed of 4 bits and is generated once for one slot. If the same algorithm is applied to the DRC value and the SINR value, the amount of data for processing the DRC value is 4/32=0.125 (i.e., 12.5%) of the amount of data for processing the SINR value. Therefore, a gain of 87.5% can be acquired for data throughput by hardware.

As described above, according to the present invention, a mobile terminal maintains a previous DRC value without transmitting a DRC value determined by a DRC block of the mobile terminal to a base station until it enters a stable stage in which a channel condition and the determined DRC value are matched with each other. Therefore, a mismatch between a channel condition where a DRC value sharply changes due to a sharp change in noise and the DRC value is minimized, thereby preventing a reduction in data throughput.

Furthermore, according to the present invention, a reduction in data throughput can be prevented in a condition where a sharp change in the channel condition is unreasonable. Moreover, the existing amount of data processed can be maintained in a condition where a sharp change in the channel condition is reasonable.

The present invention can also be embodied as computer readable codes on a computer readable recording medium. The computer readable recording medium is a data storage device that can store data which can thereafter be read by a computer system. Examples of the computer readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer readable recording medium can also be distributed over network-coupled computer systems so that the computer readable code is stored and executed in a distributed fashion. Also, functional programs, codes and code segments for accomplishing the present invention can be easily construed as within the scope of the invention by programmers skilled in the art to which the invention pertains.

While the invention has been shown and described with reference to a certain preferred embodiment thereof, it will be understood by those skilled in the art that various changes in form and details may be made therein without departing from the spirit and scope of the invention as defined by the appended claims and their equivalents.

What is claimed is:

1. An apparatus for post-processing a Data Rate Control (DRC) value, which is included in a mobile terminal having a DRC block for calculating a DRC value from a pilot channel signal received from a base station in a high rate packet data system, the apparatus comprising:
a DRC value comparison unit for comparing a current DRC value transmitted from the DRC block with a previous DRC value to determine if the current DRC value and the previous DRC value are equal to each other;
a slot counter for counting the number of slots to acquire a duration slot count during which the current DRC value is maintained if the current DRC value is different from the previous DRC value; and
a DRC value determination unit for determining the current DRC value as a final DRC value if the duration slot count reaches a selected slot threshold.

2. The apparatus of claim 1, wherein the slot threshold is set greater than a full span of the previous DRC value if the previous DRC value is less than the current DRC value.

3. The apparatus of claim 2, wherein the slot threshold is set equal to the full span of the previous DRC if the previous DRC is greater than the current DRC.

4. The apparatus of claim 1, wherein, if the duration slot count is less than the slot threshold, the DRC value determination unit determines the previous DRC value as the final DRC value.

5. The apparatus of claim 1, wherein if the previous DRC value is less than the current DRC value, the slot threshold is set as follows:
Slot Threshold (TH)=MAX (½ times a full span of C_DRC, 2 times a full span of P_DRC)
where C_DRC indicates the current DRC value, P_DCR indicates the previous DRC value, and MAX indicates an operator for selecting a larger value between two values.

6. The apparatus of claim 1, wherein, if the previous DRC value is greater than the current DRC value, the slot threshold is set as follows:
Slot Threshold (TH)=MAX (½ times a full span of C_DRC, full span of P_DRC)
where C_DRC indicates the current DRC value, P_DCR indicates the previous DRC value, and MAX indicates an operator for selecting a larger value between two values.

7. The apparatus of claim 1, further comprising a means for determining a Cyclic Redundancy Check (CRC) result with respect to the previous DRC value, wherein, if the CRC result is normal, the DRC value determination unit determines the current DRC value as the final DRC value.

8. The apparatus of claim 7, further comprising a means for comparing the packet size of the current DRC value with the packet size of the previous DRC value and the current DRC value with the previous DRC value if the CRC result is abnormal;
wherein the DRC value determination unit determines:
the current DRC as the final DRC value if the packet size of the current DRC value is the same as the packet size of the previous DRC value and the previous DRC value is greater than the current DRC value; and
the previous DRC value as the final DRC value if the packet size of the current DRC value is the same as the packet size of the previous DRC value and the previous DRC value is equal to or less than the current DRC value.

9. A method for post-processing a Data Rate Control (DRC) value for a mobile terminal having a DRC block for calculating a DRC value from a pilot channel signal received from a base station in a high rate packet data system, the method comprising:
comparing a current DRC value transmitted from the DRC block with a previous DRC value to determine if the current DRC value and the previous DRC value are equal to each other;
counting the number of slots to acquire a duration slot count during which the current DRC value is maintained if the current DRC value is different from the previous DRC value; and
determining the current DRC value as a final DRC value if the duration slot count reaches a predetermined slot threshold.

10. The method of claim 9, further comprising setting the slot threshold greater than a full span of the previous DRC value if the previous DRC value is less than the current DRC value.

11. The method of claim 10, further comprising setting the slot threshold equal to the full span of the previous DRC if the previous DRC is greater than the current DRC.

12. The method of claim 9, further comprising determining the previous DRC value as the final DRC value if the duration slot count is less than the slot threshold.

13. The method of claim 9, further comprising setting the slot threshold as follows, if the previous DRC value is less than the current DRC value:
Slot Threshold (TH)=MAX (½ times a full span of C_DRC, 2 times a full span of P_DRC)
where C_DRC indicates the current DRC value, P_DCR indicates the previous DRC value, and MAX indicates an operator for selecting a larger value between two values.

14. The method of claim 13, further comprising setting the slot threshold as follows, if the previous DRC value is greater than the current DRC value:
Slot Threshold (TH)=MAX (½ times a full span of C_DRC, full span of P_DRC)
where C_DRC indicates the current DRC value, P_DCR indicates the previous DRC value, and MAX indicates an operator for selecting a larger value between two values.

15. The method of claim 9, further comprising:
determining a Cyclic Redundancy Check (CRC) result with respect to the previous DRC value; and
determining the current DRC value as the final DRC value if the CRC result is normal.

16. The method of claim 15, further comprising:
comparing the packet size of the current DRC value with the packet size of the previous DRC value and the current DRC value with the previous DRC value if the CRC result is abnormal;
determining the current DRC as the final DRC value if the packet size of the current DRC value is the same as the packet size of the previous DRC value and the previous DRC value is greater than the current DRC value; and
determining the previous DRC value as the final DRC value if the packet size of the current DRC value is the same as the packet size of the previous DRC value and the previous DRC value is equal to or less than the current DRC value.

17. A mobile terminal for calculating a Data Rate Control (DRC) value from a pilot channel signal received from a base station in a high rate packet data system, the mobile terminal comprising:
a modem module including a DRC block for calculating the DRC value every slot based on the strength of the pilot channel signal and a Cyclic Redundancy Check (CRC) result with respect to a decoded packet; and
a DRC value post-processor for determining whether a current DRC value transmitted from the DRC block is equal to a previous DRC value, counting the number of slots to acquire a duration slot count during which the current DRC value is maintained if the current DRC value is different from the previous DRC value, and determining the current DRC value as a final DRC value if the duration slot count reaches a predetermined slot threshold.

18. The mobile terminal of claim 17, wherein the DRC value post-processor sets the slot threshold greater than a full span of the previous DRC value if the previous DRC value is less than the current DRC value.

19. The mobile terminal of claim 18, wherein the DRC value post-processor sets the slot threshold equal to the full span of the previous DRC if the previous DRC is greater than the current DRC.

20. The mobile terminal of claim 17, wherein the DRC value post-processor determines the previous DRC value as the final DRC value if the duration slot count is less than the slot threshold.

21. The mobile terminal of claim 17, wherein if the previous DRC value is less than the current DRC value, the DRC value post-processor sets the slot threshold as follows:
Slot Threshold (TH)=MAX (½ times a full span of C_DRC, 2 times a full span of P_DRC)
where C_DRC indicates the current DRC value, P_DCR indicates the previous DRC value, and MAX indicates an operator for selecting a larger value between two values.

22. The mobile terminal of claim 21, wherein if the previous DRC value is greater than the current DRC value, the DRC value post-processor sets the slot threshold as follows:
Slot Threshold (TH)=MAX (½ times a full span of C_DRC, full span of P_DRC)
where C_DRC indicates the current DRC value, P_DCR indicates the previous DRC value, and MAX indicates an operator for selecting a larger value between two values.

23. The mobile terminal of claim 17, wherein the DRC value post-processor comprises:
determining a Cyclic Redundancy Check (CRC) result with respect to the previous DRC value; and
determining the current DRC value as the final DRC value if the CRC result is normal.

24. The mobile terminal of claim 23, wherein the DRC value post-processor is configured to:
compare the packet size of the current DRC value with the packet size of the previous DRC value and the current DRC value with the previous DRC value if the CRC result is abnormal;
determine the current DRC as the final DRC value if the packet size of the current DRC value is the same as the packet size of the previous DRC value and the previous DRC value is greater than the current DRC value; and
determine the previous DRC value as the final DRC value if the packet size of the current DRC value is the same as the packet size of the previous DRC value and the previous DRC value is equal to or less than the current DRC value.

25. A computer readable medium having stored thereon a computer program for executing a method for post-processing a Data Rate Control (DRC) value for a mobile terminal having a DRC block for calculating a DRC value from a pilot channel signal received from a base station in a high rate packet data system, the method comprising:
a first set of instructions for determining a current DRC value as a selected DRC value when at least one condition exists that is selected from the group consisting of (1) a previous DRC value and the current DRC value are equal to each other, (2) the previous DRC value is greater than the current DRC value, (3) when a CRC result with respect to the previous DRC is not acquired, and (4) when a duration slot count of a temporary DRC value obtained from a slot counter reaches a selected slot threshold;
a second set of instructions for determining determines the previous DRC value as the selected DRC value when at least one condition exists that is selected from the group consisting of (1) the previous DRC value is less than the current DRC value, (2) a slot threshold for the temporary DRC value is set, and (3) the duration slot count of the temporary DRC value obtained from the slot counter does not reach the slot threshold.

26. A computer readable medium as claimed in claim 25, further comprising a third set of instructions for selectively increasing or decreasing the slot threshold according to a channel condition.

27. A computer readable medium as claimed in claim 25, wherein a mobile terminal uses at least one of the first set of instructions and the second set of instructions to determine a DRC value, and further comprising a fourth set of instructions for maintaining the previous DRC value at a mobile terminal without transmitting the determined DRC value to a base station until a stable condition is reached whereby the channel condition and the determined DRC value are matched.
